(19) United States
(12) Patent Application Publication
(10) Pub. No.: US 2025/0289227 A1
(43) Pub. Date: Sep. 18, 2025

(54) INKJET RECORDING APPARATUS

(71) Applicant: KYOCERA Document Solutions Inc., Osaka (JP)

(72) Inventors: Tatsuhiko YOSHII, Osaka (JP); Takashi MORITA, Osaka (JP)

(73) Assignee: KYOCERA Document Solutions Inc., Osaka (JP)

(21) Appl. No.: 19/068,853

(22) Filed: Mar. 3, 2025

(30) Foreign Application Priority Data
Mar. 14, 2024 (JP) 2024-040098

(51) Int. Cl. B41J 2/165

(52) U.S. Cl. CPC B41J 2/16508; B41J 2002/16594

(57) ABSTRACT

An inkjet recording apparatus includes a recording head, a cap, a cleaning liquid supply portion, a supply port, and a liquid level adjusting portion. The cleaning liquid supply portion supplies a cleaning liquid to a closed space between an ink ejection surface of the recording head and the cap. The liquid level adjusting portion adjusts a liquid level of the cleaning liquid in the closed space so that a liquid surface of the cleaning liquid stored in the closed space contacts the ink ejection surface and so that the cleaning liquid is prevented from leaking out of the closed space.

### INCORPORATION BY REFERENCE

This application is based upon and claims the benefit of priority from the corresponding Japanese Patent Application No. 2024-040098 filed on Mar. 14, 2024, the entire contents of which are hereby incorporated by reference.

### BACKGROUND

The present disclosure relates to an inkjet recording apparatus.

Inkjet recording apparatuses, which record images by ejecting ink onto recording media such as paper, are capable of recording high-definition images and thus have been widely used as recording apparatuses such as printers and copy machines. In such an inkjet recording apparatus, ink remaining on ink ejection surfaces of recording heads may become solidified to cause an ejection failure. To address this issue, there are known conventional techniques for removing ink solidified on the ink ejection surfaces, such as capping the ink ejection surfaces, immersing the ink ejection surfaces in a cleaning liquid, and cleaning (wiping) the ink ejection surfaces.

### SUMMARY

An inkjet recording apparatus according to one aspect of the present disclosure includes a recording head, a cap, a cleaning liquid supply portion, a supply port, and a liquid level adjusting portion. The recording head includes an ink ejection surface having openings of nozzles for ejecting ink onto a recording medium. The cap is attachable to and detachable from the ink ejection surface and caps the ink ejection surface. The cleaning liquid supply portion supplies a cleaning liquid to a closed space between the ink ejection surface and the cap. The supply port is provided in the cap so that the cleaning liquid flows therethrough into an inside of the cap. The liquid level adjusting portion adjusts a liquid level of the cleaning liquid in the closed space so that a liquid surface of the cleaning liquid stored in the closed space contacts the ink ejection surface and so that the cleaning liquid is prevented from leaking out of the closed space.

### BRIEF DESCRIPTION OF THE DRAWINGS

FIG. 1 is a schematic sectional front view of an inkjet recording apparatus according to one embodiment of the present disclosure.

FIG. 2 is a plan view of and around a recording portion in the inkjet recording apparatus in FIG. 1.

FIG. 3 is a block diagram showing a schematic configuration of the inkjet recording apparatus in FIG. 1.

FIG. 4 is a side view of a recording head in FIG. 2.

FIG. 5 is a bottom view of the recording head in FIG. 2.

FIG. 6 is a perspective view of the recording portion and a maintenance unit in the inkjet recording apparatus in FIG. 1.

FIG. 7 is a perspective view of a capping unit of the maintenance unit in FIG. 6.

FIG. 8 is an explanatory view showing configurations of the recording head in FIG. 4, the capping unit, and a cleaning liquid supply portion.

FIG. 9 is an explanatory view showing configurations of a recording head, a capping unit, and a cleaning liquid supply portion according to Modification Example 1.

FIG. 10 is an explanatory view showing configurations of a recording head, a capping unit, and a cleaning liquid supply portion according to Modification Example 2.

### DETAILED DESCRIPTION

With reference to the appended drawings, the following describes an embodiment of the present disclosure. The present disclosure is not limited to what is described below.

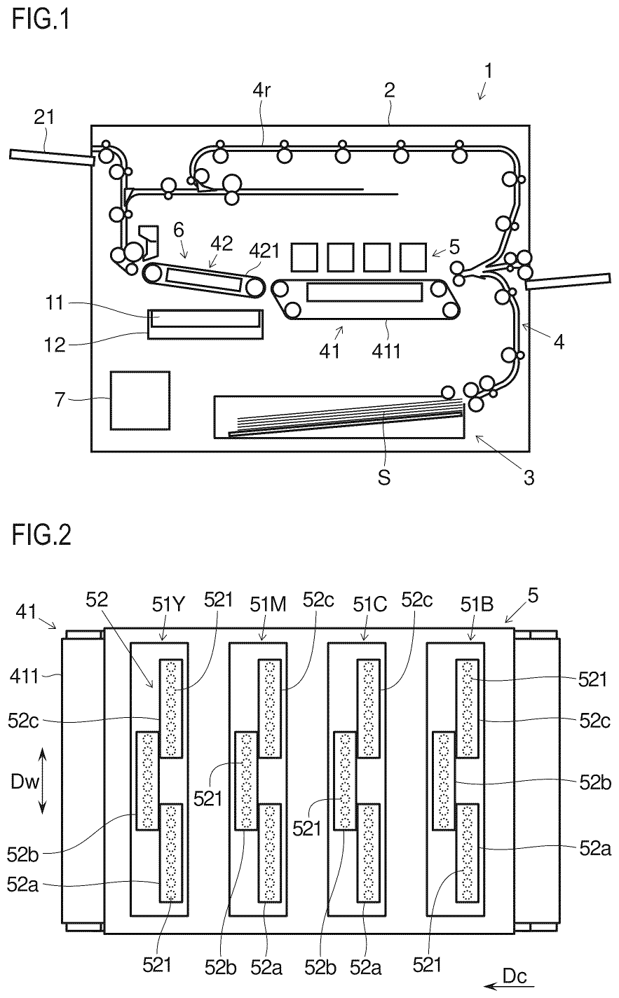

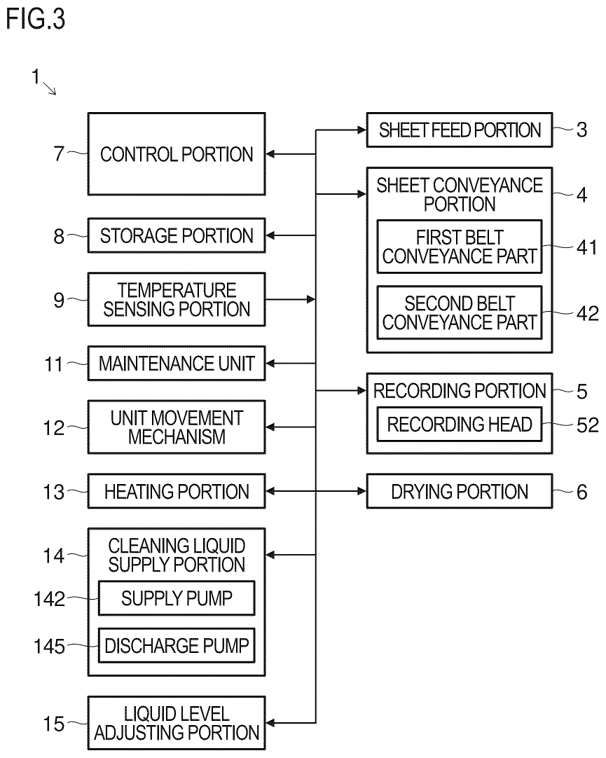

FIG. 1 is a schematic sectional front view of an inkjet recording apparatus 1 according to the embodiment. FIG. 2 is a plan view of and around a recording portion 5 in the inkjet recording apparatus 1 in FIG. 1. FIG. 3 is a block diagram showing a schematic configuration of the inkjet recording apparatus 1 in FIG. 1. The inkjet recording apparatus 1 is, for example, a printer of an inkjet recording type. As shown in FIGS. 1, 2, and 3, the inkjet recording apparatus 1 includes an apparatus main body 2, a sheet feed portion 3, a sheet conveyance portion 4, the recording portion 5, a drying portion 6, a control portion 7, and a storage portion 8.

The sheet feed portion 3 is arranged, for example, in a lower part of the apparatus main body 2. The sheet feed portion 3 contains a plurality of sheets (recording media) S and feeds out the sheets S one by one separately during recording.

The sheet conveyance portion 4 is arranged downstream from the sheet feed portion 3 in a sheet conveyance direction and conveys the sheet S fed out from the sheet feed portion 3. The sheet conveyance portion 4 conveys the sheet S to the recording portion 5 and to the drying portion 6 and further discharges the sheet S that has been subjected to recording and drying to a sheet discharge portion 21. Furthermore, the sheet conveyance portion 4 includes, for example, a reverse conveyance part 4r. In a case of performing duplex recording, the sheet conveyance portion 4 steers the sheet S whose first side has been subjected to recording and drying to the reverse conveyance part 4r and further conveys, again to the recording portion 5 and to the drying portion 6, the sheet S whose conveyance direction has been switched so that front and back sides thereof are reversed.

The sheet conveyance portion 4 includes a first belt conveyance part 41 and a second belt conveyance part 42. The first belt conveyance part 41 includes a first conveyance belt 411 formed to be endless. The second belt conveyance part 42 includes a second conveyance belt 421 formed to be endless. The first belt conveyance part 41 and the second belt conveyance part 42 convey the sheet S while the sheet S is held by suction on upper outer surfaces (upper surfaces) of the first conveyance belt 411 and the second conveyance belt 421, respectively. The first belt conveyance part 41 is arranged below the recording portion 5 and conveys the sheet S. Being positioned downstream relative to the first belt conveyance part 41 in the sheet conveyance direction, the second belt conveyance part 42 is arranged in the drying portion 6 and conveys the sheet S.

The recording portion 5 is positioned downstream from the sheet feed portion 3 in the sheet conveyance direction and is arranged to be opposed to the first belt conveyance part 41. The recording portion 5 is opposed to the sheet S being conveyed while being held by suction on the upper surface of the first conveyance belt 411 and is arranged above the first conveyance belt 411 at a prescribed distance therefrom. That is, the recording portion 5 is opposed to the sheet S being conveyed by the sheet conveyance portion 4.

As shown in FIG. 2, the recording portion 5 holds head units 51B, 51C, 51M, and 51Y corresponding to four different colors of black, cyan, magenta, and yellow, respectively. The head units 51B, 51C, 51M, and 51Y are arranged side by side along a sheet conveyance direction Dc so that a longitudinal direction thereof is parallel to a sheet width direction Dw orthogonal to the sheet conveyance direction Dc. The four head units 51B, 51C, 51M, and 51Y are the same in basic configuration, and thus in the following description, unless particularly required to be limited, identification symbols “B,” “C,” “M,” and “Y” representing the respective colors may be omitted.

Each of the head units 51 of the respective colors includes a line-type inkjet recording head 52. In each of the head units 51 of the respective colors, a plurality of (for example, three (52a, 52b, 52c)) recording heads 52 are arrayed in a staggered manner along the sheet width direction Dw.

The recording head 52 includes a plurality of ink ejection nozzles 521 provided at a bottom part thereof. The plurality of ink ejection nozzles 521 are arranged next to each other along the sheet width direction Dw, and through them, ink can be ejected over an entire recording region on the sheet S. That is, the recording head 52 includes the plurality of ink ejection nozzles 521 for ejecting ink onto the sheet S. The recording portion 5 ejects ink sequentially from the recording heads 52 of the head units 51B, 51C, 51M, and 51Y of the four different colors toward the sheet S being conveyed by the first conveyance belt 411, thus recording a full-color image or a monochrome image on the sheet S.

The drying portion 6 is arranged downstream relative to the recording portion 5 in the sheet conveyance direction, and the second belt conveyance part 42 is provided therein. In the drying portion 6, the sheet S on which an ink image has been recorded in the recording portion 5 is conveyed while being held by suction on the second conveyance belt 421, and ink on the sheet S is dried during this conveyance.

The control portion 7 includes a CPU and other electronic circuits and electronic components (none of them are shown). Based on control programs or data stored in the storage portion 8, the CPU controls operations of various constituent elements provided in the inkjet recording apparatus 1 so as to perform processes related to functions of the inkjet recording apparatus 1. The sheet feed portion 3, the sheet conveyance portion 4, the recording portion 5, and the drying portion 6 individually receive, from the control portion 7, instructions to perform recording on the sheet S in collaboration with each other.

The storage portion 8 is formed of a combination of, for example, a nonvolatile storage device such as a program ROM (read-only memory) or a data ROM and a volatile storage device such as a RAM (random-access memory).

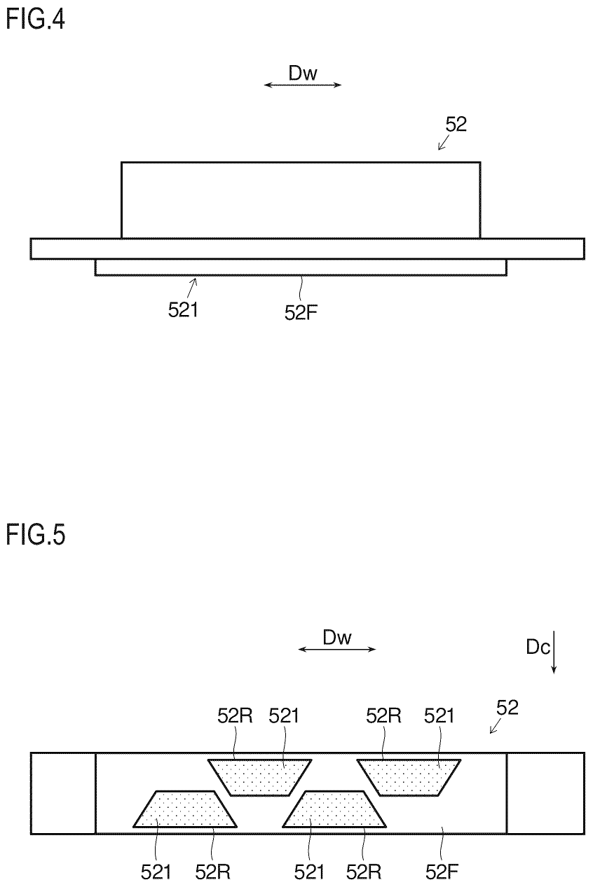

Next, with reference to FIGS. 4 and 5, a description is given of a configuration of the recording head 52 in the recording portion 5. FIGS. 4 and 5 are respectively a side view and a bottom view of the recording head 52 in FIG. 2. The three recording heads 52a, 52b, and 52c of each of the respective colors are identical in shape and configuration, and thus in the following description, identification symbols (a, b, c) are omitted.

The recording head 52 includes an ink ejection surface 52F provided on a lower surface thereof. The ink ejection surface 52F is opposed to a surface (an upper surface) of the sheet S being conveyed on the first conveyance belt 411. As shown in FIG. 5, the ink ejection surface 52F includes a nozzle region 52R in which a multitude of ink ejection nozzles 521 are arrayed. That is, the ink ejection surface 52F has openings of the multitude of ink ejection nozzles 521, through which ink is ejected onto the sheet S. A water-repellent film (not shown) is formed on the ink ejection surface 52F. The recording heads 52 of the four different colors (black, cyan, magenta, and yellow) are individually supplied with inks of four different colors stored in ink tanks external to the head units 51, respectively.

Based on a control signal from the control portion 7 and in accordance with image data received from an external computer, the recording head 52 ejects ink through the ink ejection nozzles 521 toward the sheet S being conveyed while being held by suction on a conveyance surface of the first conveyance belt 411. To be more specific, the control portion 7 inputs, to the recording head 52, an ejection drive signal having a set prescribed drive voltage and a set prescribed pulse width so that the recording head 52 is driven to eject ink through the ink ejection nozzles 521. Thus, on the sheet S on the first conveyance belt 411, there is formed a color image of superimposed inks of four different colors of black, cyan, magenta, and yellow or a monochrome image.

As shown in FIGS. 1 and 3, the inkjet recording apparatus 1 also includes a temperature sensing portion 9, a maintenance unit 11, a unit movement mechanism 12, a heating portion 13, a cleaning liquid supply portion 14, and a liquid level adjusting portion 15.

The temperature sensing portion 9 senses an ambient temperature around an installation location of the inkjet recording apparatus 1. The temperature sensing portion 9 is formed of, for example, a thermistor.

In a case of not executing a maintenance process with respect to the recording heads 52, as shown in FIG. 1, the maintenance unit 11 is arranged at a first position below the second belt conveyance part 42.

In the inkjet recording apparatus 1, the maintenance process with respect to the recording heads 52 is executed at a predetermined timing. The maintenance process with respect to the recording heads 52 is executed, for example, at a start of recording after an extended period of non-operation or during an interval between recording operations. In a case of executing the maintenance process with respect to the recording heads 52, the control portion 7 controls the unit movement mechanism 12 to move the maintenance unit 11 to a second position below the recording portion 5.

During the maintenance process with respect to the recording heads 52, by a conveyance part movement mechanism (not shown), the first belt conveyance part 41 arranged to be opposed to a lower surface of the recording portion 5 is retracted below a position thereof shown in FIG. 1 to near the sheet feed portion 3. After that, the maintenance unit 11 is moved to the second position below the recording portion 5 and is brought closer to the ink ejection surfaces 52F.

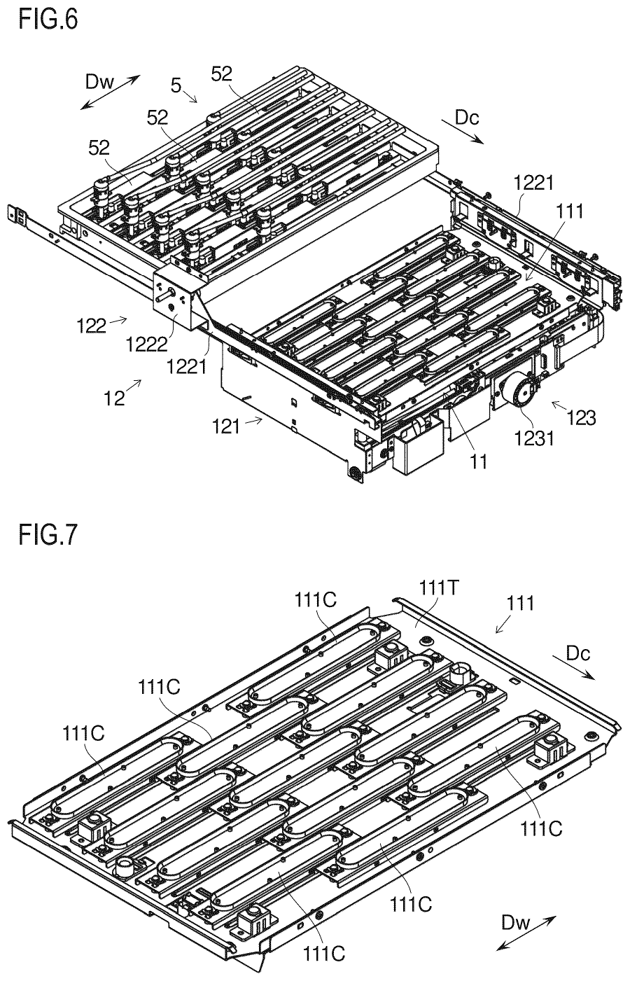

FIG. 6 is a perspective view of the recording portion 5 and the maintenance unit 11 in the inkjet recording apparatus 1 in FIG. 1. FIG. 7 is a perspective view of a capping unit 111 of the maintenance unit 11 in FIG. 6.

The maintenance unit 11 includes the capping unit 111. During the maintenance process with respect to the recording heads 52, the capping unit 111 is arranged at a capping position for capping the ink ejection surfaces 52F and is mounted to the lower surface of the recording portion 5. The capping unit 111 includes a tray 111T and a cap 111C. The tray 111T is formed in a rectangular shape extending horizontally in the sheet conveyance direction Dc and in the sheet width direction Dw.

The cap 111C is arranged on an upper surface of the tray 111T. The cap 111C is arranged at each of positions corresponding to the plurality of recording heads 52a, 52b, and 52c arrayed in a staggered manner along the sheet width direction Dw for each of the respective colors. That is, in this embodiment, the capping unit 111 includes twelve caps 111C. The cap 111C is formed in a downwardly recessed concave shape.

The cap 111C is attachable to and detachable from the ink ejection surface 52F and caps the ink ejection surface 52F. When the capping unit 111 is arranged at the capping position for capping the ink ejection surfaces 52F, the bottom part of the recording head 52 enters an inside of the cap 111C so that a closed space is formed between the ink ejection surface 52F and the cap 111C.

The unit movement mechanism 12 is arranged below either of the recording portion 5 and the drying portion 6. The unit movement mechanism 12 includes a carriage 121, a horizontal movement mechanism 122, and an ascending/descending mechanism 123 and supports the maintenance unit 11.

The carriage 121 is supported to the horizontal movement mechanism 122. The carriage 121 is formed in a rectangular parallelepiped box shape having an open upper surface and houses the maintenance unit 11 inside. The carriage 121 further holds the ascending/descending mechanism 123.

The horizontal movement mechanism 122 includes a guide rail 1221 and a motor 1222.

The guide rail 1221 is arranged on each of one and the other sides of the horizontal movement mechanism 122 in the sheet width direction Dw and extends horizontally from below the recording portion 5 to below the drying portion 6 along the sheet conveyance direction Dc. The maintenance unit 11 is supported to the guide rail 1221 so as to be horizontally movable along the guide rail 1221. The capping unit 111 is independently supported above the carriage 121.

The motor 1222 is arranged adjacently to the guide rail 1221, and an output shaft thereof is linked to the capping unit 111 and to the carriage 121 via a group of gears, a wire and a pulley, or the like (none of them are shown). Upon driving of the motor 1222, the horizontal movement mechanism 122 horizontally moves the capping unit 111 and the carriage 121 along the sheet conveyance direction Dc. The horizontal movement mechanism 122 is capable of horizontally moving the capping unit 111 and the carriage 121 independently of each other.

The ascending/descending mechanism 123 includes a support mechanism (not shown) and a motor 1231. The support mechanism is arranged in an inner bottom part of the carriage 121. The support mechanism supports a bottom part of the maintenance unit 11 and is connected to the motor 1231 via a group of gears, a wire and a pulley, or the like (none of them are shown).

Upon activation of the motor 1231, the ascending/descending mechanism 123 drives the support mechanism to push up or pull down the maintenance unit 11, thus causing the maintenance unit 11 to ascend or descend. That is, the capping unit 111 is caused to ascend or descend by the ascending/descending mechanism 123.

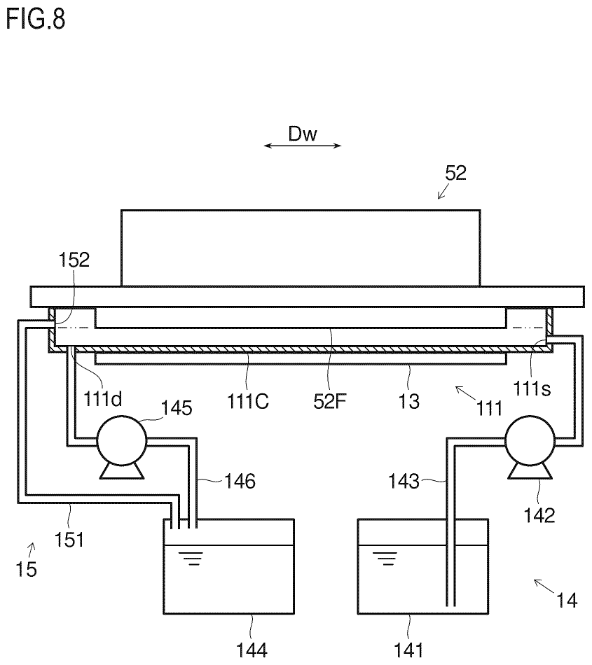

FIG. 8 is an explanatory view showing configurations of the recording head 52 in FIG. 4, the capping unit 111, and the cleaning liquid supply portion 14.

The heating portion 13 is individually affixed to an outer bottom surface of each of the plurality of caps 111C of the capping unit 111. The heating portion 13 is formed of, for example, a plate-shaped heater. The heating portion 13 heats the cap 111C. In other words, via the cap 111C, the heating portion 13 heats a cleaning liquid stored in the cap 111C. An operation of the heating portion 13 is controlled by the control portion 7.

The cleaning liquid supply portion 14 supplies the cleaning liquid to the closed space between the ink ejection surface 52F and the cap 111C. The cleaning liquid supply portion 14 includes a cleaning liquid tank 141, a supply pump 142, a supply tube 143, a waste liquid tank 144, a discharge pump 145, and a discharge tube 146.

The cleaning liquid tank 141 is connected to the cap 111C via the supply tube 143. The supply tube 143 is connected to the cap 111C, and the cap 111C has a supply port 111s through which the cleaning liquid flows into the inside of the cap 111C.

The cleaning liquid tank 141 contains the cleaning liquid to be supplied into the cap 111C. The supply pump 142 is arranged downstream relative to the cleaning liquid tank 141 in a cleaning liquid supply direction. The supply pump 142 sucks the cleaning liquid in the cleaning liquid tank 141 and ejects it toward the cap 111C. In other words, the supply pump 142 delivers the cleaning liquid toward the closed space between the ink ejection surface 52F and the cap 111C. An operation of the supply pump 142 is controlled by the control portion 7.

The waste liquid tank 144 is connected to the cap 111C via the discharge tube 146. The discharge tube 146 is connected to the cap 111C, and the cap 111C has a discharge port 111d through which the cleaning liquid inside the cap 111C flows out.

The waste liquid tank 144 contains a used cleaning liquid (a waste liquid) that has been supplied into the cap 111C and used for cleaning of the ink ejection surface 52F. The discharge pump 145 is arranged upstream relative to the waste liquid tank 144 in a cleaning liquid discharge direction. The discharge pump 145 sucks the cleaning liquid (the waste liquid) in the cap 111C and ejects it toward the waste liquid tank 144. An operation of the discharge pump 145 is controlled by the control portion 7.

The liquid level adjusting portion 15 includes an overflow tube 151 and an overflow port 152. The overflow tube 151 connects the cap 111C to the waste liquid tank 144 by a route different from the discharge tube 146. The overflow port 152 is provided in a side wall of the cap 111C, and the overflow tube 151 is connected thereto.

In the cap 111C, the overflow port 152 is arranged above a height level of the ink ejection surface 52F. When a liquid level of the cleaning liquid stored in the closed space between the ink ejection surface 52F and the cap 111C reaches a height level of the overflow port 152, the cleaning liquid overflows into the overflow tube 151 through the overflow port 152 and thus is delivered to the waste liquid tank 144. In other words, a liquid surface of the cleaning liquid stored in the closed space between the ink ejection surface 52F and the cap 111C contacts the ink ejection surface 52F, and when the liquid level becomes higher than the height level of the ink ejection surface 52F, the cleaning liquid overflows through the overflow port 152.

That is, the liquid level adjusting portion 15 adjusts the liquid level of the cleaning liquid in the closed space between the ink ejection surface 52F and the cap 111C so that the liquid surface of the cleaning liquid stored in the closed space contacts the ink ejection surface 52F and so that the cleaning liquid is prevented from leaking out of the closed space.

According to the above-described configuration, the liquid surface of the cleaning liquid stored in the closed space of the cap 111C contacts the ink ejection surface 52F, and the cleaning liquid is prevented from leaking out of the closed space of the cap 111C. This can suppress a phenomenon in which the liquid level of the cleaning liquid reaches a part of the recording head 52 beyond the height level of the ink ejection surface 52F, so that the cleaning liquid adheres thereto. Accordingly, it is possible to suppress penetration of the cleaning liquid into the recording head 52 and thus to prevent occurrence of a malfunction of the recording head 52 caused by the penetration of the cleaning liquid thereinto. This makes it possible to favorably maintain ink ejection performance of the recording head 52.

Furthermore, the liquid level adjusting portion 15 causes an excess of the cleaning liquid beyond the height level of the ink ejection surface 52F in the closed space of the cap 111C to overflow through the overflow port 152. According to this configuration, it is possible to easily adjust the liquid level of the cleaning liquid so that the liquid surface of the cleaning liquid in the closed space of the cap 111C contacts the ink ejection surface 52F and so that the cleaning liquid is prevented from leaking out of the closed space. This makes it possible to suppress, using a simple configuration, the phenomenon in which the liquid level of the cleaning liquid reaches a part of the recording head 52 beyond the height level of the ink ejection surface 52F, so that the cleaning liquid adheres thereto.

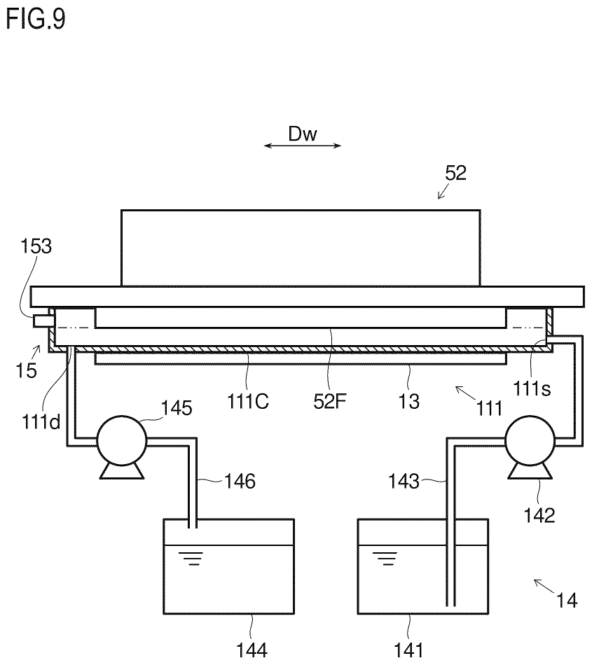

FIG. 9 is an explanatory view showing configurations of a recording head 52, a capping unit 111, and a cleaning liquid supply portion 14 according to Modification Example 1. A liquid level adjusting portion 15 in an inkjet recording apparatus 1 according to Modification Example 1 includes a liquid level sensor 153.

The liquid level sensor 153 is provided at a cap 111C. The liquid level sensor 153 is formed of, for example, a level gauge or a level switch of a capacitance type, an electrode type, a supersonic type, an electric wave type, an optical type, or the like. The liquid level sensor 153 is configured and arranged so as to be capable of sensing a position (a height) of a liquid surface of a cleaning liquid in the cap 111C. The liquid level sensor 153 senses a liquid level of the cleaning liquid in a closed space between an ink ejection surface 52F and the cap 111C. A sensed value obtained by the liquid level sensor 153 is transmitted to a control portion 7.

Further, based on the sensed value obtained by the liquid level sensor 153, the control portion 7 controls a supply pump 142 so that the liquid surface of the cleaning liquid in the cap 111C contacts the ink ejection surface 52F. According to this configuration, it is possible to adjust the liquid level of the cleaning liquid with high accuracy so that the liquid surface of the cleaning liquid in the closed space of the cap 111C contacts the ink ejection surface 52F and so that the cleaning liquid is prevented from leaking out of the closed space.

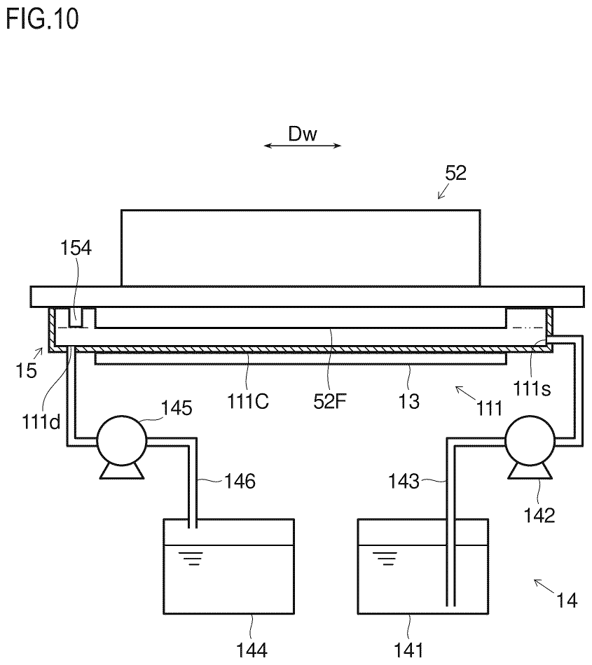

FIG. 10 is an explanatory view showing configurations of a recording head 52, a capping unit 111, and a cleaning liquid supply portion 14 according to Modification Example 2. A liquid level adjustment portion 15 in an inkjet recording apparatus 1 according to Modification Example 2 includes a liquid level sensor 154.

The liquid level sensor 154 is provided at the recording head 52. Similarly to the liquid level sensor 153 according to Modification Example 1 described with reference to FIG. 9, the liquid level sensor 154 is also formed of, for example, the level gauge or the level switch of the capacitance type, the electrode type, the supersonic type, the electric wave type, the optical type, or the like. The liquid level sensor 154 is configured and arranged so as to be capable of sensing a position (a height) of a liquid surface of a cleaning liquid in a cap 111C. The liquid level sensor 154 senses a liquid level of the cleaning liquid in a closed space between an ink ejection surface 52F and the cap 111C. A sensed value obtained by the liquid level sensor 154 is transmitted to a control portion 7.

Further, based on the sensed value obtained by the liquid level sensor 154, the control portion 7 controls a supply pump 142 so that the liquid surface of the cleaning liquid in the cap 111C contacts the ink ejection surface 52F. According to this configuration, it is possible to adjust the liquid level of the cleaning liquid with high accuracy so that the liquid surface of the cleaning liquid in the closed space of the cap 111C contacts the ink ejection surface 52F and so that the cleaning liquid is prevented from leaking out of the closed space.

While the foregoing has described the embodiment of the present disclosure, the present disclosure is not limited in scope thereto and can be implemented in variously modified forms without departing from the spirit of the disclosure.

What is claimed is:

1. An inkjet recording apparatus, comprising:
a recording head that includes an ink ejection surface having openings of nozzles for ejecting ink onto a recording medium;
a cap that is attachable to and detachable from the ink ejection surface and caps the ink ejection surface;
a cleaning liquid supply portion that supplies a cleaning liquid to a closed space between the ink ejection surface and the cap;
a supply port that is provided in the cap so that the cleaning liquid flows therethrough into an inside of the cap; and
a liquid level adjusting portion that adjusts a liquid level of the cleaning liquid in the closed space so that a liquid surface of the cleaning liquid stored in the closed space contacts the ink ejection surface and so that the cleaning liquid is prevented from leaking out of the closed space.

2. The inkjet recording apparatus according to claim 1, wherein
the liquid level adjusting portion has an overflow port that is arranged above a height level of the ink ejection surface in the cap and through which the cleaning liquid in the closed space overflows.

3. The inkjet recording apparatus according to claim 1, further comprising:
a supply pump that is provided in the cleaning liquid supply portion and delivers the cleaning liquid toward the closed space; and
a control portion that controls an operation of the supply pump,
wherein
the liquid level adjusting portion includes a liquid level sensor that senses the liquid level of the cleaning liquid in the closed space, and
based on a sensed value obtained by the liquid level sensor, the control portion controls the supply pump so that the liquid surface of the cleaning liquid contacts the ink ejection surface.

4. The inkjet recording apparatus according to claim 3, wherein
the liquid level sensor is provided at the cap.

5. The inkjet recording apparatus according to claim 3, wherein
the liquid level sensor is provided at the recording head.
